(19) United States
(12) Patent Application Publication
(10) Pub. No.: US 2004/0132911 A1
(43) Pub. Date: Jul. 8, 2004

(54) Predispersions, process for their preparation, compositions therefor, process for the preparation of such compositions

(76) Inventor: Vipin Sharma, New Delhi (IN)

Correspondence Address: LADAS & PARRY, 26 WEST 61ST STREET, NEW YORK, NY, 10023, US

(21) Appl. No.: 10/471,353

(22) PCT Filed: Mar. 13, 2002
(86) PCT No.: PCT/IN02/00044

(30) Foreign Application Priority Data
Mar. 12, 2001 (IN) 286/DEL/2001

(51) Int. Cl. C08F 8/00

(52) U.S. Cl. 525/196

(57) ABSTRACT

The present invention relates to predispersions of rubber chemicals and to a process for the preparation thereof. The present invention also relates to a novel polymeric composition for dispersing a rubber chemical and to a process for the preparation of said composition.

### FIELD OF THE INVENTION

The present invention relates to predispersions of rubber chemicals and to a process for the preparation thereof. The present invention also relates to a composition for dispersing a rubber chemical and to a process for the preparation of said composition.

### BACKGROUND OF THE INVENTION

Vulcanisation of rubber is a well recognised step to obtain enhanced properties such as improved consistency. A large number of rubber chemicals are used during vulcanizing of rubber. They include vulcanizing agents like Sulfur, activators like ZnO, accelerators, retarders etc. Most of these chemicals are in powder form.

The process of vulcanising diene rubbers by heating with sulphur and a vulcanisation accelerator has been known for many years. By this process, vulcanisates having certain physical properties, for instance tensile strength, resilience and fatigue resistance at a high level can be obtained. However, it is observed that such vulcanisates tend not to have good aging properties. Apart from the addition of antioxidants which will retard oxidative heat aging, other methods which have been proposed for making vulcanisates having improved aging properties include the use of lower proportions of sulphur relative to those which would be employed for a conventional cure, and the partial or complete replacement of sulphur by other cross-linking agents.

The use of powders has its inherent disadvantages in terms of dusting, creation of fines, etc. It is therefore common in the art to use dispersions of rubber chemicals to overcome these problems.

While related prior art describes pre-weighed powder chemicals, the use of the pre-weighed powder chemicals is plagued with problems inherent to powders. For example, the use of powders presents housekeeping problems resulting from the difficulty of cleaning spilled powders. When added to blenders such as Banbury or mills, varying amounts of the powders have a tendency to be removed by the dust collecting system. The loss of variable amounts of the powders can adversely affect the amounts and ratios in which the powders are used and also affect batch-to-batch consistency of products that are made therewith. Powders have the tendency to mix unevenly. They have the tendency to find dead spots in mixers and thus avoid mixing consistently on a batch-to-batch basis. Some powders have the tendency to agglomerate during storage or form plates during mixing. Both phenomena lead to poor dispersions that ultimately translate into products such as vulcanisates with varying or unacceptable properties. No matter how carefully handled, powders have the tendency to get on the hands and clothes of workers handling them and thereby create health hazards. Powders have the tendency to stick to bags, thus changing the amounts added each time and making disposal of the bags environmentally challenging.

Prior art discloses several methods for the formation of dispersions of rubber chemicals for use in rubber and plastic processing. One such method is the formation of master batches on two roll mills or in internal mixers, such as of the Banbury type. Another method disclosed in the prior art is the formation of pastes of the rubber additives using binders such as various oils and other plasticizers, low molecular weight non-crystalline polymers and waxes prepared in three roll mills, which pastes are then shaped in an extruder (for example U.S. Pat. No. 3,000,841). Another method disclosed in the prior art is that of partial encapsulation wherein the rubber chemical is treated again with various liquids such as oils or propionic acid. This involves the formation not of a true dispersion but of a partial encapsulation.

U.S. Pat. No. 4,092,285 discloses a dispersed rubber chemical composition comprising the rubber chemical in a binder selected from waxes and liquids that are compatible with the rubber chemical such as extender oils and chemical plasticizers selected from chlorosulfonated polyethylene, ethylene-propylene terpolymers, natural rubber and neoprene.

U.S. Pat. No. 4,394,473 discloses bales of unvulcanized rubber, vulcanized rubber or compounding ingredients for unvulcanized rubber packaged in films or bags made from sydiotactic 1,2-polybutadiene containing at least one anti-blocking agent and at least one slip agent additive. Co-extrusions can be used to manufacture bags or films having two or more layers where only the inside layer is heavily loaded with an anti-block agent. The outside layer contains only a minimal amount of anti-block agent with both layers containing slip agents. The disadvantage of such films and the pre-weighed packages made from them is the relatively high mixing temperatures required to soften the wrapping materials sufficiently in order to obtain homogeneous incorporation into the stocks to which they are added. The films and bags only totally disperse in internal mixers such as Banburys, but do not homogeneously disperse into the mixed stock when using a mill. This disadvantage is operational regardless of whether contents are powders or pre-dispersed chemical dispersions.

Pre-dispersions of rubber chemicals in the form of polymer bound powders/liquids are known in the art. The major benefits of such pre-dispersions as against direct use of rubber chemical in powder or liquid form are the:

Handling ease

Less scrap and rework due to better quality compound

Better consistency of mix cycles due to more accurate weighing and incorporation into compound

Reduced material loss due to dust and spillage

Improved morale due to cleaner work environment

Positive impact on environmental and health issues

Reduced housekeeping and associated waste disposal costs

U.S. Pat. No. 5,624,988 granted to Bauer et al discloses a process for the production of polymer bound rubber chemicals. The rubber chemicals and optional additives are finely dispersed in a low molecular weight polymerisable liquid, polymerisation initiated after the optional addition of a component reacting with the polymerisable liquid to form a polymer. The solid, homogeneous mixture of rubber chemicals and the polymer so formed is if desired converted into a form suitable for use.

U.S. Pat. No. 5,716,702 Schuette, et al. relates to a unitary packaging system comprising pre-dispersed chemicals in pre-weighed quantities in multiple, separated compartments of a masterbatch. Also encompassed by the invention is a method of packaging rubber chemicals for storage and delivery to blending equipment comprising providing pre-dispersions of the chemicals; incorporating the chemicals into a masterbatch to provide a homogeneous mixture. Further encompassed by the invention is a process for reducing chemical behavior or eutectic behavior of chemicals by packaging the chemicals as pre-dispersed chemicals in pre-weighed quantities in multiple separated compartments of a masterbatch. The unitary packaging system of this invention can be described as an envelope of masterbatch material having sealed therein compartments of chemicals that are separated from one another. The masterbatch material of the packaging system (packaging masterbatch) is of a composition that is compatible with the composition of the “base masterbatch” to which the packaging system is added. Preferably, the masterbatch material is of a composition that is the same as the composition of the “base masterbatch”. The materials of the respective masterbatch can be made of polymers and a combination of fillers, plasticizers, processing promoters, antioxidants, tackifiers, zinc oxide and others. The polymers of this disclosure are selected from the group consisting of natural rubber, synthetic rubber, thermoplastic elastomers and mixtures thereof. The synthetic elastomers are exemplified by EPDM (ethylene-propylene diene monomer rubber), EPM (ethylene-propylene monomer rubber), EVA (ethylene-vinylacetate rubber), CPE (chlorinated polyethylene rubber), IIR (polyisobutylene), IR (polyisoprene), SBR (styrene-butadiene rubber), NBR (acrylonitrile-butadiene rubber), CM (chlorosulfonated polyethylene rubber), CR (polychlorprene rubber).

U.S. Pat. No. 4,665,155 of Devaux, et al. discloses vulcanisates having improved properties can be obtained by adding polymeric trithiocarbonates in addition to sulphur and a vulcanisation accelerator during the compounding of diene rubbers. These materials have the effect of stabilising the properties of the vulcanisate if the temperature of the vulcanisate unavoidably remains high for a prolonged period after cure, and during the service life of the vulcanisate. A vulcanisable rubber composition is provided comprising a diene rubber, sulphur and a vulcanisation accelerator, characterised in that the composition also contains a polymeric trithiocarbonate having a structure comprising repeating units with an organic bridging group. Vulcanisates made using such alternative systems tend, however, to lack certain of the merits of a sulphur-cured vulcanisate, and there is therefore a need for additives which will improve the aging properties of the vulcanisate while retaining the merits of using sulphur as the vulcanising agent.

The prior art polymeric dispersions for rubber chemicals have so far concentrated on the formation of polymeric blends using chemical methods or physical methods such as extrusion. It is observed that such prior art polymeric blends do not offer good compression set or good aging properties required for preparation of pre-dispersions of rubber chemicals.

### OBJECTS OF THE INVENTION

It is an object of the invention to provide polymer bound rubber chemicals which show less dusting.

Another object of the invention is to provide polymer bound rubber chemicals which show better performance in terms of better scorch safety and heat aging properties.

It is another object of the invention to provide a polymeric blend which allows dispersion of rubber chemicals in desired loading percentages while requiring less amount of the final predispersion to be used in the processing of rubbers.

It is another object of the invention to provide a cost effective and environmentally friendly method for the preparation of dispersions of rubber chemicals.

### SUMMARY OF THE INVENTION

These and other objects of the invention are achieved by providing the rubber additives dispersed in a novel polymeric blend.

Accordingly, the present invention provides a predispersion of a rubber additive comprising a rubber additive dispersed in a polymeric blend of a (i) a polymeric component, (ii) a rubbery material, and (iii) a low molecular weight hydrocarbon.

In one embodiment of the invention, the amount of the rubber additive in the predispersion comprises from 40 to 95% by weight and that of the polymeric blend comprises 60 to 5% by weight of the total predispersion.

In another embodiment of the invention, the rubber additive is selected from the group consisting of accelerators, antioxidants, activators, stabilizers, retarders, blowing agents, sulfur donors, curing agents, cross-linking activators, peroxides, flame retardants, processing promoters, peptizing agents, reclaiming agents, dispersants, lubricants, dispersing resins, homogenizers, tackifiers, reinforcers and cross-linking agents.

In another embodiment of the invention, the rubber additive is selected from the group consisting of sulphur, 2-mercaptobenzotriazole, tetramethylthiuram disulfide, benzothazyl disulfide, zinc dibutyldithiocarbamate, zinc diethyldithiocarbamate, N-cyclohexyl-2-benzothazyl sulfenamide and N-oxydiethylene-2-benzothiazylsulfenamide.

In another embodiment of the invention, the polymeric component of the blend is selected from the group consisting of copolymers of ethylene and vinyl acetate, ethylene-butyl acrylate copolymers, ethylene methyl acrylate copolymers, ethylene acrylic acid copolymers and derivatives thereof such as ethylene acrylic ester and maleic anhydride terpolymer, copolymers of ethylene and alkyl acrylate and metal ionomers of copolymers of ethylene with acids.

In a further embodiment of the invention, the amount of vinyl acetate in the ethylene vinyl acetate copolymer is in the range of 12 to 50% of the polymer.

In another embodiment of the invention, the copolymers of ethylene and alkyl acrylate are selected from the group consisting of ethylenemethyl acrylate copolymers, ethyleneethyl acrylate copolymers, ethylenepropyl acrylate copolymers, ethylenebutyl acrylate copolymers, ethylenebutyl acrylate/carbon monoxide terpolymers, ethyleneethyl acrylate/maleic anhydride terpolymers and ethyleneacrylate/glycidyl methacrylate terpolymers.

In a further embodiment of the invention, the metal ionomers of copolymers of ethylene with acid comprises metal ionomer of copolymer of ethylene with methacrylic acid.

In a further embodiment of the invention, the metal is selected from the group consisting of zinc, sodium and lithium or salts thereof.

In another embodiment of the invention, the rubbery component of the polymeric blend is selected from the group consisting of terpolymers of ethylene, propylene and a diene such as ethylene-propylene-diene monomer rubber, copolymers of ethylene and propylene such as ethylene propylene rubber, ethylene acrylate rubber, neoprene and natural rubber.

In yet another embodiment of the invention, the low molecular weight hydrocarbon component of the polymeric blend is selected from the group consisting of polyisobutene, atactic polypropylene, liquid polypropylene and low molecular weight waxes, whether grafted or not.

The present invention also relates to a process for the preparation of a predispersion of a rubber additive comprising a rubber additive dispersed in a polymeric blend of a (i) a polymeric component, (ii) a rubbery material, and (iii) a low molecular weight hydrocarbon, said process comprising mixing said additive in said polymeric blend.

In one embodiment of the invention, the amount of the rubber additive in the predispersion comprises from 5 to 95% by weight and that of the polymeric blend comprises 95 to 5% by weight of the total predispersion.

In another embodiment of the invention, the rubber additive is selected from the group consisting of accelerators, antioxidants, activators, stabilizers, retarders, blowing agents, sulfur donors, curing agents, cross-linking activators, peroxides, flame retardants, processing promoters, peptizing agents, reclaiming agents, dispersants, lubricants, dispersing resins, homogenizers, tackifiers, reinforcers and cross-linking agents.

In another embodiment of the invention, the rubber additive is selected from the group consisting of sulphur, 2-mercaptobenzotrizole, tetramethylthiuram disulfide, benzothazyl disulfide, zinc dibutyldithiocarbamate, zinc diethyldithiocarbamate, N-cyclohexyl-2-benzothazyl sulfenamide and N-oxydiethylene-2-benzothiazylsulfenamide.

In another embodiment of the invention, the polymeric component of the blend is selected from the group consisting of copolymers of ethylene and vinyl acetate, ethylene-butyl acrylate copolymers, ethylene methyl acrylate copolymers, ethylene methacrylic acid copolymers, ethylene acrylic acid copolymers, ethylene acrylic acid copolymers and derivatives thereof such as ethylene acrylic ester and maleic anhydride terpolymer, copolymers of ethylene and alkyl acrylate and metal ionomers of copolymers of ethylene with acids, and any derivatives thereof.

In another embodiment of the invention, the copolymers of ethylene and alkyl acrylate are selected from the group consisting of ethylenemethyl acrylate copolymers, ethyleneethyl acrylate copolymers, ethylenepropyl acrylate copolymers, ethylenebutyl acrylate copolymers, ethylenebutyl acrylate/carbon monoxide terpolymers, ethyleneethyl acrylate/maleic anhydride terpolymers and ethyleneacrylatelglycidyl methacrylate terpolymers, and any derivatives thereof.

In a further embodiment of the invention, the metal ionomers of copolymers of ethylene with acid comprises metal ionomers of copolymer of ethylene with methacrylic acid.

In a further embodiment of the invention, the metal is selected from the group consisting of zinc, sodium and lithium or salts thereof.

In another embodiment of the invention, the rubbery component of the polymeric blend is selected from the group consisting of terpolymers of ethylene, propylene and a diene such as ethylene-propylene-diene monomer rubber, copolymers of ethylene and propylene such as ethylene propylene rubber, ethylene acrylate rubber, neoprene and epoxidised natural rubber.

In yet another embodiment of the invention, the low molecular weight hydrocarbon component of the polymeric blend is selected from the group consisting of polyisobutene, atactic polypropylene, liquid polypropylene and low molecular weight waxes whether grafted or not.

In one embodiment of the invention, the mixing of the rubber additive in the said polymeric blend is carried out by melt mixing in a kneader.

In one embodiment of the invention, the process for the preparation of the predispersion comprises first forming the polymeric blend by any conventional means such as melt mixing and subsequently dispersing the rubber additive therein by melt mixing.

In another embodiment of the invention, the predispersion is prepared by first mixing the polymeric component rubbery component and then adding the low molecular weight hydrocarbon and the rubber additive simultaneously thereto to form the final predispersion.

In another embodiment of the invention, all components of the predispersion are simultaneously melt mixed to obtain the predispersion.

The invention also relates to a polymeric blend for use in the preparation of predispersions of rubber additives comprising (i) a polymeric component, (ii) a rubbery material, and (iii) a low molecular weight hydrocarbon.

In one embodiment of the invention, the polymeric component of the blend is selected from the group consisting of copolymers of ethylene and vinyl acetate, ethylene-butyl acrylate copolymers, ethylene methyl acrylate copolymers, ethylene acrylic acid copolymers and derivatives thereof such as ethylene acrylic ester and maleic anhydride terpolymer, Copolymers of ethylene and alkyl acrylate and metal ionomers of copolymers of ethylene with acids, and any derivatives thereof.

In another embodiment of the invention, the copolymers of ethylene and alkyl acrylate are selected from the group consisting of ethylenemethyl acrylate copolymers, ethyleneethyl acrylate copolymers, ethylenepropyl acrylate copolymers, ethylenebutyl acrylate copolymers, ethylenebutyl acrylate/carbon monoxide terpolymers, ethyleneethyl acrylate/maleic anhydride terpolymers and ethyleneacrylate/glycidyl methacrylate terpolymers, and any derivatives thereof.

In a further embodiment of the invention, the metal ionomers of copolymers of ethylene with acid comprises metal ionomers of copolymer of ethylene with methacrylic acid.

In a further embodiment of the invention, the metal is selected from the group consisting of zinc, sodium and lithium or salts thereof.

In another embodiment of the invention, the rubbery component of the polymeric blend is selected from the group consisting of terpolymers of ethylene, propylene and a diene such as ethylene-propylene-diene monomer rubber, copolymers of ethylene and propylene such as ethylene propylene rubber, ethylene acrylate rubber, neoprene and epoxidised natural rubber.

In yet another embodiment of the invention, the low molecular weight hydrocarbon component of the polymeric blend is selected from group consisting of polyisobutene, atactic polypropylene, liquid polypropylene and low molecular weight waxes whether grafted or not.

In another embodiment of the invention, the amount of the polymeric component of the polymeric blend in the range of 5 to 70% by weight of the total blend.

In another embodiment of the invention, the amount of the rubbery compound in the polymeric blend is in the range of 15 to 70% by weight of the total blend.

In a further embodiment of the invention, the amount of the low molecular weight hydrocarbon in the polymeric blend is in the range of 10 to 80% by weight of the total blend.

In another embodiment of the invention, the polymeric component is selected from ethylene vinyl acetate and ethylene vinyl butylate, the rubbery component comprises ethylene-propylene diene monomer rubber (EPDM), and the lower molecular weight hydrocarbon is an unsaturated polyolefin with 3 or more carbon atoms.

In yet another embodiment of the invention, the polymeric blend may additionally comprise one or more conventional ingredients selected from plasticizers, thickeners, viscosity enhancers, binders and waxes.

The invention also provides a process for the preparation of a polymeric blend for use in the preparation of predispersions of rubber additives comprising (i) a polymeric component, (ii) a rubbery material, and (iii) a low molecular weight hydrocarbon.

In one embodiment of the invention, the polymeric component of the blend is selected from the group consisting of copolymers of ethylene and vinyl acetate, ethylene-butyl acrylate copolymers, ethylene methyl acrylate copolymers, ethylene methacrylic acid copolymers, ethylene acrylic acid copolymers, ethylene acrylic acid copolymers and derivatives thereof such as ethylene acrylic ester and maleic anhydride terpolymer, Copolymers of ethylene and alkyl acrylate and metal ionomers of copolymers of ethylene with acids, and any derivatives thereof.

In another embodiment of the invention, the copolymers of ethylene and alkyl acrylate are selected from the group consisting of ethylenemethyl acrylate copolymers, ethyleneethyl acrylate copolymers, ethylenepropyl acrylate copolymers, ethylenebutyl acrylate copolymers, ethylenebutyl acrylate/carbon monoxide terpolymers, ethyleneethyl acrylate/maleic anhydride terpolymers and ethyleneacrylate/glycidyl methacrylate terpolymers, and any derivatives thereof.

In a further embodiment of the invention, the metal ionomers of copolymers of ethylene with acid comprises metal ionomers of copolymer of ethylene with methacrylic acid.

In a further embodiment of the invention, the metal is selected from the group consisting of zinc, sodium and lithium or salts thereof.

In another embodiment of the invention, the rubbery component of the polymeric blend is selected from terpolymers of ethylene, propylene and a diene such as ethylene-propylene-diene monomer rubber, copolymers of ethylene and propylene such as ethylene propylene rubber, ethylene acrylate rubber, neoprene and epoxidised natural rubber.

In yet another embodiment of the invention, the low molecular weight hydrocarbon component of the polymeric blend is selected from group consisting of polyisobutene, atactic polypropylene, liquid polypropylene and low molecular weight waxes whether grafted or not.

In another embodiment of the invention, the amount of the polymeric component of the polymeric blend in the range of 5 to 70% by weight of the total blend.

In another embodiment of the invention, the amount of the rubbery compound in the polymeric blend is in the range of 15 to 70% by weight of the total blend.

In a further embodiment of the invention, the amount of the low molecular weight hydrocarbon in the polymeric blend is in the range of 10 to 80% by weight of the total blend.

In yet another embodiment of the invention, the polymeric blend may additionally comprise one or more conventional ingredients selected from plasticizers, thickeners, binders, viscosity modifying agents and waxes.

In yet another embodiment of the invention, the polymeric blend is formed by first melt mixing the polymeric component and the rubbery component to obtain a first blend and then adding the low molecular weight hydrocarbon to obtain the final composition.

In another embodiment of the invention, all components of the polymeric blend are melt mixed simultaneously to obtain the final blend.

The compositions of the invention are synergistic compositions with unexpected and improved properties and not mere admixes displaying a mere aggregate of the properties of the individual ingredients.

### DETAILED DESCRIPTION OF THE INVENTION

The present invention is based on the surprising recognition that an blend made of various unsaturated polyolefins or various copolymers thereof or their derivatives offer better performance as predispersions due to enhancement of properties in the pre-dispersion. Without being bound by any theory, the applicants believe that the enhancement of properties in the masterbatch due to the use of the novel polymer blend occurs since the polymer blend gets into the backbone and thus offers better reactivity of sulphur or other rubber chemicals.

The invention provides a predispersion of a rubber additive comprising a rubber additive dispersed in a polymeric blend of a (i) a polymeric component, (ii) a rubbery material, and (iii) a low molecular weight hydrocarbon. The amount of the rubber additive in the predispersion is preferably from 5 to 95% by weight and that of the polymeric blend is 95 to 5% by weight of the total predispersion.

The rubber additive can be any conventional critical rubber chemical and can be for example selected from accelerators, antioxidants, activators, stabilizers, retarders, blowing agents, sulfur donors, curing agents, cross-linking activators, peroxides, flame retardants, processing promoters, peptizing agents, reclaiming agents, dispersants, lubricants, dispersing resins, homogenizers, tackifiers, reinforcers and cross-linking agents. Examples of such rubber chemicals comprise sulphur, 2-mercaptobenzotriazole, tetramethylthiuram disulfide, benzothazyl disulfide, zinc dibutyldithiocarbamate, zinc diethyldithiocarbamate, N-cyclohexyl-2-benzothazyl sulfenamide and N-oxydiethylene-2-benzothiazylsulfenamide.

The polymer blend used to form the predispersion of the invention comprises a polymeric component such as copolymers of ethylene and vinyl acetate, ethylene-butyl acrylate copolymers, ethylene methyl acrylate copolymers (available commercially as LOTRYL® sold by Atofina), ethylene acrylic acid copolymers and derivatives thereof such as ethylene acrylic ester and maleic anhydride terpolymer (available commercially as LOTADER® sold by Atofina), Copolymers of ethylene and alkyl acrylate (available commercially as PRIMACOR™ sold by Dow Chemical Company) and metal ionomers of copolymers of ethylene with acids. While higher amounts of the acid substituent in the polymeric component are preferred, better results are achieved when the amount of the acid substituent in the polymeric component is at least 12% by weight. For example, the amount of vinyl acetate in the ethylene vinyl acetate copolymer can be in the range of 12 to 50% of the polymer.

The copolymers of ethylene and alkyl acrylate can be for example ethylenemethyl acrylate copolymers, ethyleneethyl acrylate copolymers, ethylenepropyl acrylate copolymers, ethylenebutyl acrylate copolymers, ethylenebutyl acrylate/carbon monoxide terpolymers, ethyleneethyl acrylate/maleic anhydride terpolymers and ethyleneacrylate/glycidyl methacrylate terpolymers. The metal ionomers of copolymers of ethylene with acid comprises a metal ionomer of copolymer of ethylene with methacrylic acid (available commercially as SURLYN® sold by DuPont). The metal can be selected from the group consisting of zinc, sodium and lithium or salts thereof.

The rubbery component of the polymeric blend is selected from the group consisting of ethylene-propylene-diene monomer rubber such as those sold by DuPont Dow Elastomers under the trademark NORDEL®, ethylene propylene rubber or by Bayer under the trademark Buna®, ethylene acrylate rubber, polychroprene and its various copolymers which are commercially available from DuPont as NEOPRENE®, and epoxidised natural rubber.

The low molecular weight hydrocarbon component of the polymeric blend is preferably a lower hydrocarbon with up to 3 carbon atoms. The lower hydrocarbon can be polyisobutene, atactic polypropylene, liquid polypropylene and low molecular weight waxes whether grafted or not. The molecular weight of the hydrocarbon is preferably in the range of from 150 to 6000, more preferably between 300 to 3000, though hydrocarbons with higher molecular weights can also be used.

The predispersion of a rubber additive is prepared generally by any conventional method such as melt mixing or kneading or in a two roll mill. The mixing of the rubber additive in the said polymeric blend is carried out by melt mixing in a intermix or on a two roll mill, preferably at a temperature below 56° C. in order to prevent any deleterious effect on the properties of the final predispersion formed. The predispersion can be formed in a one step method comprising melt mixing of all the ingredients or by first forming a preliminary blend of the rubbery component and the polymeric component and then mixing in the rubber chemical and the lower molecular weight hydrocarbon.

The polymeric blend can additionally comprise one or more conventional ingredients selected from plasticizers, thickeners, viscosity enhancers, binders and waxes. The polymeric blend can be prepared according to the process described above. It is not essential that the rubber chemical be mixed or dispersed immediately into the polymeric blend.

It is observed that the polymeric dispersion of the invention offers the following advantages over the available prior art.

Lesser material consumption, higher profit

Lesser consumption of material, environmental benefits

The invention provides a polymer blend comprising polymer phase comprising various unsaturated polyolefins or various copolymers or terpolymers thereof or their derivatives.

Most unsaturated polyolefins or various copolymers or terpolymers thereof or their derivatives can be employed to form the polymeric blend. One factor determining the actual choice of polyolefins will lie in the cost factor. Most preferred of the polymeric blends useful for the formulation of presdispersions of rubber chemicals as prepared according to the invention are made from a combination of ethylene-propylene diene monomer rubber (EPDM), ethylene vinyl acetate or ethylene vinyl butylate and an unsaturated polyolefin with 3 or more carbon atoms.

It is observed that contrasted to the prior art pre-dispersions consisting of blends or mixes of polyolefins, the predispersion of the invention is required in less dosage with improved properties over prior art pre-dispersions. It is observed that the compression set of the pre-dispersion of the invention is lower than that of the prior art, as is the scorch resistance and aging properties.

The polymeric blends of the invention can be prepared by any conventional polymer blending process. The polymer and rubber can be first melt mixed with subsequent addition of the rubber additive and the low molecular weight hydrocarbon. In the alternative all the ingredients of the predispersion can be mixed together. The mixing can be done in a mixer/kneader or in a two roll mill. Tests show that both the methods of preparation of predispersions, whether made on a two roll mill or on an intermix type of kneader, give products that yield same results in rubber compounds. However, for ease of operation, it is preferred to use a kneader instead of a two roll mill and carry out the mixing of the ingredients in a step wise manner instead of simultaneously.

The invention will now be described with reference to the following examples which are illustrative and should not be construed as limiting the scope of the invention.

### EXAMPLE 1

2.5 kg of Ethylene Vinyl Acetate having 28% Vinyl Acetate content (Grade 2825 supplied by National Organic Chemical Industries Ltd., Mumbai, India) was melt mixed with 5 kg of EPDM rubber (Keltan Grade no. 4802 supplied DSM N. V. Netherlands) in an intermix type of kneader (applied by Extrusion Systems, New Delhi, India). The polymers were melt mixed in the kneader at 90° C. for around 18-20 minutes. 1.5 kg of the polymer blend obtained was taken in another mixer/kneader and 10 kg sulfur was added to the same along with 1 kg polyisobutene (grade PV 10 Manufactured by Gujarat Petrosynthesis Ltd. and marketed by Indian Petrochemicals Corporation Ltd., Vadodara, India). The sulfur additive has been ground in a nitrogen blanket to ensure a particle size of 500-750 mesh before addition to the polymer blend. The resulting mixture was melt mixed in the kneader. Care was taken to ensure that the processing temperature did not cross 56° C. to prevent any deleterious effect on the properties of the final predispersion. The dough so obtained was fed to a granulator with a cooling provision. Free flowing, non-sticking, granules of sulfur dispersion were obtained.

### EXAMPLE 2

0.5 kg of Ethylene Vinyl Acetate having 28% Vinyl Acetate content (Grade 2825 supplied by National Organic Chemical Industries Ltd., Mumbai, India) was melt mixed with 1 kg of EPDM rubber (Keltan Grade no. 4802 supplied DSM N. V. Netherlands) in an intermix type of kneader (supplied by Extrusion Systems, New Delhi, India). 10 kg sulphur was added to the same along with 1 kg PIB (grade PV 10 Manufactured by Gujarat Petrosynthesis Ltd. and marketed by Indian Petrochemicals Corporation Ltd., Vadodara, India).

The sulphur mentioned above had been ground in a nitrogen blanket to ensure a particle size of 500-750 mesh. The polymers were melt mixed in the intermix kneader.

Care was taken to ensure that the processing temperature did not cross 56° C. to prevent any deleterious effect on the properties of the final predispersion.

The dough so obtained was fed to a granulator with a cooling provision. Free flowing, non-sticking, granules of sulphur dispersion were obtained.

### EXAMPLE 3

2.5 kg of EVA having 40% Vinyl Acetate content. (Grade Sumitate RB 11, manufactured by Sumitomo Chemical Co. Ltd., Osaka, Japan and supplied by their agents in India, M/s. Kemeff Value Additives, Mumbai, India) was melt mixed with 5 kg of EPDM rubber (Keltan Grade no. 4802 supplied DSM N. V. Netherlands) in a intermix type of kneader (supplied by Extrusion Systems, New Delhi, India).

The polymers were melt mixed in the kneader at 90° C. for 18-20 minutes to obtain a preliminary polymer blend. 1.5 kg of the polymer blend obtained above was taken in another mixer/kneader. 10 kg sulfur was added to the same along with 1 kg PIB (grade PV 10 Manufactured by Gujarat Petrosynthesis Ltd. and marketed by Indian Petrochemicals Corporation Ltd., Vadodara, India). The sulfur mentioned above had been ground in nitrogen blanket to ensure a particle size of approximately 500-750 mesh. The melt reaction was done in kneader.

Care was taken to ensure that the processing temperature did not cross 56° C. in order to prevent any deleterious effect on the properties of the final predispersion. The dough so obtained was fed to a granulator with a cooling provision to obtain free flowing, non-sticking, granules of sulfur dispersion. Granules obtained herein were softer compared to granules made in Example 1.

### EXAMPLE 4

5 kg of Ethylene Vinyl Acetate having 28% Vinyl Acetate content (Grade 2825 supplied by National Organic Chemical Industries Ltd., Mumbai, India) was melt mixed with 5 kg of EPDM rubber (Keltan Grade no. 4802 supplied DSM N. V. Netherlands) in a intermix type of kneader (supplied by Extrusion Systems, New Delhi, India). The polymers were melt mixed in the kneader at 90° C. for around 18-20 minutes to obtain a polymer blend. 1 kg of the polymer blend obtained above was taken in another mixer/kneader. 10 kg sulfur was added to the same along with 1.5 kg PIB (grade PV 10 Manufactured by Gujarat Petrosynthesis Ltd. and marketed by Indian Petrochemicals Corporation Ltd., Vadodara, India). The sulfur mentioned above had been ground in nitrogen blanket to ensure a particle size of approximately 500-750 mesh. The melt reaction was done in kneader. Care was taken to ensure that the process-ing temperature did not cross 56° C. to prevent any deleterious effect on the properties of the predispersion. The dough so obtained was fed to a granulator with a cooling provision.

The granules of sulfur dispersion obtained in this case were stickier compared to those obtained in Example 1.

### EXAMPLE 5

Procedure of Example 1 was repeated with identical operational parameters with sulfur being replaced by MBT (2-mercaptobenzothiazole) manufactured by NOCIL (Rubber Chemicals Division), Mumbai, India. Uniform dispersions of MBT are obtained.

### EXAMPLE 6

The procedure of Example 1 was repeated with identical operation parameters with MBT being replaced by MBTS (benzothiazyl disulfide) manufactured by NOCIL, Mumbai, India. The operational parameters and steps were identical. Uniform dispersions of MBTS were obtained.

### EXAMPLE 7

The procedure of Example 1 was repeated with MBT being replaced by TMTD (tetramethylthiuram disulfide) manufactured by NOCIL, Mumbai, India. The operational parameters and steps were identical. Uniform dispersions of TMTD were obtained.

### EXAMPLE 8

The procedure of Example 1 was repeated with MBT being replaced by ZDBC (zinc dibutyldithiocarbamate) manufactured by NOCIL, Mumbai, India. The operational parameters and steps were identical. Uniform dispersions of ZDBC were obtained.

### EXAMPLE 9

The procedure of Example 1 was repeated with MBT being replaced by ZDEC (zinc diethyldithiocarbamate) manufactured by NOCIL, Mumbai, India. The operational parameters and steps were identical. Uniform dispersions of ZDEC were obtained.

### EXAMPLE 10

The procedure of Example 5 was repeated with MBT being replaced by CBS (N-cyclohexyl-2-benzothiazyl sulfenamide) manufactured by NOCIL, Mumbai, India. The operational parameters and steps were identical. Uniform dispersions of CBS were obtained.

### EXAMPLE 11

A rubber compound having typical formulation used in manufacture of “hard” type of weatherstrip profile used in automobiles was prepared.

| | |
|---|---|
| EPDM | 100 parts |
| Process Oil | 87 phr |
| Ca CO₃ Filler | 45 phr |
| Carbon Black | |
| FEF 550 | 100 phr |
| GPF 660 | 50 phr |
| Zinc Oxide | 5 phr |
| Stearic Acid | 2 phr |
| PEG | 1.3 phr |
| Calcium Oxide | 9 phr |

A typical curing composition for such formulations used in the prior art consists of

| | |
|---|---|
| MBT | 1.8 phr |
| TMTD | 0.67 phr |
| ZDEC | 0.67 phr |
| ZDBC | 1.0 phr |
| Sulfur | 1.2 phr |

In the present example, MBT was used in the form of a predispersion (as prepared in Example 4 above) instead of as powder MBT. The processing steps for the rubber formulation being processed were conventional.

It was observed that instead of 1.8 phr MBT powder as required in the art, only 90% dosage i.e 1.62 phr of the predispersion form, i.e. only 90% dosage was required to obtain the same effects. Since the active content of MBT in the predispersion is only 80%, effectively only 72% dosage of MBT (i.e. 1.296 phr) was added. All other ingredients were used in the powder form.

The curing system used was:

| | |
|---|---|
| MBT in predispersion form | 1.62 phr |
| made as in Example 4 | |
| Powder TMTD | 0.67 phr |
| ZDEC | 0.67 phr |
| ZDBC | 1.0 phr |
| Sulfur | 1.2 phr |

The mixing and compounding were done using conventional methods as used for powder ingredients.

The rubber was cured and tested. Properties obtained by using only 72% dosage of MBT in the form of predispersion were found to be same as if 100% powder MBT had been used.

### EXAMPLE 12

A formulation as per example 11 was prepared. In the present example, however, while MBT and other ingredients of the curing system was added in the form of a powder, sulphur was taken in the form of a predispersion in place of powder sulphur.

The dosage of sulphur masterbatch was only 80% of the powder sulphur. This means that only 64% of sulphur that would have been used in powder form was used.

The new and old formulations are given below in Table 1.

TABLE 1
New and old formulations of curing systems

| Old formulation | Old dosage |
|---|---|
| Powder MBT | 1.8 phr |
| Powder TMTD | 0.67 phr |
| Powder ZDEC | 0.67 phr |
| Powder ZDBC | 1.0 phr |
| Powder Sulfur | 1.2 phr |
| New formulation | New dosage |
| Powder MBT | 1.8 phr |
| Powder TMTD | 0.67 phr |
| Powder ZDEC | 0.67 phr |
| Powder ZDBC | 1.0 phr |
| Sulphur in predispersion | 0.96 phr |
| form made as in | |
| Example 1 | |

It is important to note that only Sulphur has been taken in the form of predispersion, and that too at a 80% dosage of powder, yielding an effective sulphur dosage of 0.768 phr compared to 1.2 phr of powder. If was found that on the blender mill the mixing cycle that was earlier ˜15 minutes was reduced by 100 seconds to ˜800 seconds. Significantly, these results were obtained even though only one component of the curing system, namely sulphur was in the form of predispersion. The curing of the rubber compound yielded same hardness and other values, the rheometer curve obtained was table top curve (FIG. 1).

### EXAMPLE 13

Formulation as per example 11 was prepared. However now MBT and other ingredients of the curing system were added in powder form and the predispersion of TMTD prepared as per the invention was used in place of powder TMTD. The dosage of TMTD masterbatch was only 90% of the powder TMTD. This means that only 72% of TMTD that would have been used in powder form was used. The new and old formulations are given below in Table 2.

TABLE 2
New and old formulation of curing systems

| Old formulation | Old dosage |
|---|---|
| Powder MBT | 1.8 phr |
| Powder TMTD | 0.67 phr |
| Powder ZDEC | 0.67 phr |
| Powder ZDBC | 1.0 phr |
| Powder Sulfur | 1.2 phr |
| New formulation | New dosage |
| Powder MBT | 1.8 phr |
| TMTD in predispersion form | 0.603 phr |
| Powder ZDEC | 0.67 phr |
| Powder ZDBC | 1.0 phr |
| Sulphur | 1.2 phr |

It is important to note that only TMTD has been taken in the form of predispersion, and that too at a 90% dosage of powder (i.e. 0.603 phr of TMTD predispersion compared to 0.67 phr of powder TMTD). This was same as having only 0.4824 phr of powder TMTD since the active content of TMTD in the predispersion is 80%. Even though only a single accelerator has been used in the form of predispersion, the complete curing took place and no under cure was observed. Similar experiments were carried out with the other accelerators and again it was found that at only 90% predispersion dosage of the accelerators, this is equivalent to 72% of the powder accelerator.

### EXAMPLE 14

Formulation as per example 11 was prepared. However now MBT and other ingredients of the curing system, except sulphur, were added in predispersion form. The dosage of all the accelerator predispersions was taken as only 90% of the powder accelerator. This means that only 72% of any accelerator that would have been used in powder form was used. The new and old formulations are given below in Table 3.

TABLE 3
New and old formulations

| Old formulation | Old dosage |
|---|---|
| Powder MBT | 1.8 phr |
| Powder TMTD | 0.67 phr |
| Powder ZDEC | 0.67 phr |
| Powder ZDBC | 1.0 phr |
| Powder Sulfur | 1.2 phr |
| New formulation | New dosage |
| MBT in predispersion form | 1.62 phr |
| TMTD in predispersion form | 0.603 phr |
| ZDEC in predispersion form | 0.603 phr |
| ZDBC in predispersion form | 0.9 phr |
| Sulphur (powder form) | 1.2 phr |

It is important to note that all the accelerators have been taken in the form of predispersion, and that too at a 90% dosage of powder (i.e. for e.g. 0.603 phr of TMTD predispersion compared to 0.67 phr of powder TMTD). This was same as having only 0.4824 phr of powder TMTD since the active content of TMTD in the predispersion is 80%. Even though all the accelerators have been used in the form of predispersion at a reduced dosage of 90% of the powder translating to 72% of the accelerator composition since the active content of the accelerators in the predispersion is 80%, complete curing took place and no under cure was observed.

### EXAMPLE 15

The procedure of Example 11 was repeated except that rubber formulation used was EPDM ASTM D 3568-95

| | |
|---|---|
| EPDM | 100 |
| Carbon n 550 | 80 |
| P O | 50 |
| ZnO | 5 |
| S A | 1 |

Curing systems prepared using powdered sulphur, imported predispersion (from Rhein Chemie) and a sulphur predispersion according to the invention were used. The curing system prepared using a sulphur predispersion of the invention comprised of

| | |
|---|---|
| Sulfur predispersion | 1.5, |
| MBT | 0.5 |
| TMT | 1 |
| DPTT | 1 |
| ZDBC | 1 |
| Desiccant | 10 |

The results obtained are given in Table 4 below. Table 4 provides a comparative analysis of the properties of ethylene propylene diene monomer rubber profiles when cured with the pre-dispersion of the invention prepared using EPDM, EVA and Isobutene as the polyolefins to form an blend when compared with both powdered sulphur and prior art pre-dispersion of sulphur. As can be seen from the data in Table 4, significantly better results in terms of curing time, dosage of sulphur required phr, were obtained. It was also observed that there was no undercure when using the predispersion prepared according to the invention. Curing was done at temp nr 155, in a 10′ motor, mdr 200, 0.5 degree arach, temp nbr 150, temp epdm 120′ motor.

### EXAMPLE 16

The procedure of Example 11 was repeated except that rubber formulation used was Nitrile

| | |
|---|---|
| NBR (Aparene) | 100 |
| Carbon 774 | 50 |
| DOP | 5 |
| Strucktol WB 350 | 3 |
| ZnO | 5 |
| St Acid | 1 |
| Pillox TDQ | 2 (A O) |

Curing systems comprising of sulfur 0.5, TMT 2, MOR 1 were used wherein the sulphur was prepared in the form of a predispersion according to the invention. the results obtained are given in Table 5 below. Table 2 provides a comparative analysis of the properties of nitrile butyl rubber profiles when cured with the pre-dispersion of the invention prepared using EPDM, EVA and Isobutene as the polyolefins to form an blend when compared with prior art pre-dispersion of sulphur. As can be seen from the data in table 4, significantly better results in terms of curing time, dosage of sulphur required phr, were obtained. It was also observed that there was no undercure.

### EXAMPLE 17

Example 15 procedure was repeated using a natural rubber formulation instead of EPDM or nitrile rubber. The procedure was identical as in Example 15. The results are given in Table 6 below. Table 6 provides a comparative analysis of the properties of natural rubber formulation when the curing is done using predispersion of sulphur made by using a polymeric blend of EPDM, EVA and polyisobutene (of the invention) and compared with prior art predispersions of sulphur as well as powder sulphur.

It will be readily apparent to a person skilled in the art that the invention is not limited to what is described above and various modifications and embodiments of the present invention are possible without departing from the spirit and scope thereof.

TABLE 4
EPDM Compound Study

| | | Rheology @ 170° C., | | | | | | | |
|---|---|---|---|---|---|---|---|---|---|
| | | 20′ motor T3 | | | | | | | |
| | | | MH | | @ | TS | TR | | 100% M |
| Tr | | TS2 | IN- | TC90 | 121° C. | Kg/ | Kg/ | Sin | Kg/ |
| No | Description | Secs | LB | Secs | Min:Sec | cm² | cm | % | Cm² |
| 1 | Powdered | 77 | 13.58 | 200 | 12.48 | 105.25 | 34.67 | 466.50 | 25.78 |
| | sulphur | | | | | | | | |
| 2 | Imported | 78 | 13.78 | 213 | 12.07 | 105.18 | 39.27 | 455.77 | 26.86 |
| | sulphur | | | | | | | | |
| 3A | 40% | 92 | 13.09 | 249 | 13.37 | 111.83 | 37.39 | 498.27 | 23.81 |
| | EPDM + EVA + IB | | | | | | | | |
| 3B | 45% | 96 | 13.09 | 287 | 13.44 | 108.43 | 35.07 | 500.10 | 23.13 |
| | EPDM + EVA + IB | | | | | | | | |
| 3C | 50% | 90 | 13.22 | 259 | 13.35 | 110.13 | 34.81 | 482.03 | 25.01 |
| | EPDM + EVA + IB | | | | | | | | |
| 3D | 55% | 84 | 13.51 | 244 | 13.38 | 108.80 | 35.95 | 475.20 | 24.15 |
| | EPDM + EVA + IB | | | | | | | | |

| | 200% | 300% | | | CHANGE AFTER HEAT/AGING @ 100° C. | | | | |
|---|---|---|---|---|---|---|---|---|---|
| | M | M | HARD. | C.S. | FOR 70 C | | | | |
| Tr | Kg/ | Kg/ | Kg/ | 70° C. | HARD | TS | TR | Sin | 100% M |
| No | cm² | Cm² | cm² | % | IRHD | % | % | % | % |
| 1 | 53.80 | 74.80 | 65.70 | 25.52 | +4.17 | −1.49 | −30.17 | −43.10 | +80.95 |
| 2 | 55.61 | 77.66 | 65.50 | 23.81 | +4.5 | +.076 | −39.01 | −44.50 | +91.51 |
| 3A | 51.33 | 72.31 | 63.70 | 13.43 | +3.5 | −15.90 | −26.21 | −37.38 | +32.69 |
| 3B | 49.85 | 70.40 | 63.17 | 12.93 | +3.0 | −9.11 | −21.79 | −35.24 | +38.63 |
| 3C | 52.05 | 74.48 | 63.33 | 12.92 | +3.5 | −6.86 | −16.23 | −37.28 | +37.86 |
| 3D | 52.20 | 73.82 | 64.10 | 13.12 | +2.17 | −3.20 | −22.70 | −32.56 | +41.06 |

TABLE 5
NITRILE RUBBER FORMULATION (Example 16)

| | | Rheology @ 155° C., | | | | | | | |
|---|---|---|---|---|---|---|---|---|---|
| | | 10′ motor T3 | | | | | | | |
| | | | MH | | @ | TS | TR | | 100% M |
| Tr | | TS2 | IN- | TC90 | 121° C. | Kg/ | Kg/ | Sin | Kg/ |
| No | Description | Secs | LB | Secs | Min:Sec | cm² | cm | % | Cm² |
| 1 | Imported | 192 | 10.48 | 450 | 15:39 | 157.30 | 45.17 | 435.57 | 33.55 |
| | sulphur | | | | | | | | |
| 2 | 50% | 266 | 8.94 | 662 | 17:24 | 163.83 | 47.96 | 561.97 | 27.83 |
| | EPDM + EVA + IB | | | | | | | | |
| 3 | 60% | 231 | 9.46 | 558 | 17:24 | 184.09 | 49.86 | 579.4 | 28.55 |
| | EPDM + EVA + IB | | | | | | | | |

| | 200% | 300% | | | CHANGE AFTER HEAT/AGING @ 100° C. | | | | |
|---|---|---|---|---|---|---|---|---|---|
| | M | M | HARD. | C.S. | FOR 70 C | | | | |
| Tr | Kg/ | Kg/ | Kg/ | 70° C. | HARD | TS | TR | Sin | 100% M |
| No | cm² | Cm² | cm² | 24 Hr | IRHD | % | % | % | % |
| 1 | 75.76 | 118.93 | 69.75 | 17.49 | +3.0 | +7.23 | −16.25 | −31.42 | +49.59 |
| 2 | 58.52 | 95.82 | 67.38 | 8.81 | +1.67 | +10.06 | +0.89 | −22.05 | +27.99 |
| 3 | 62.52 | 101.41 | 67.70 | 16.76 | +3.0 | +2.66 | −12.95 | −31.13 | +55.76 |

TABLE 6
NATURAL RUBBER FORMULATION (Example 17)

| | | Rheology @ 155° C., | | | | | | | |
|---|---|---|---|---|---|---|---|---|---|
| | | 20′ motor T3 | | | | | | | |
| | | | MH | | @ | TS | TR | | 100% M |
| Tr | | TS2 | IN- | TC90 | 121° C. | Kg/ | Kg/ | Sin | Kg/ |
| No | Description | Secs | LB | Secs | Min:Sec | cm² | cm | % | Cm² |
| 1 | Imported | 113 | 16.4 | 261 | 15:25 | 204.87 | 56.3 | 313.2 | 49.33 |
| | sulphur | | | | | | | | |
| 2 | 50% | 133 | 13.16 | 254 | 17:10 | 203.20 | 57.9 | 366.77 | 42.86 |
| | EPDM + EVA + IB | | | | | | | | |
| 3 | 55% | 125 | 14.44 | 265 | 16:03 | 200.20 | 58.06 | 318.35 | 49.85 |
| | EPDM + EVA + IB | | | | | | | | |

| | 200% | 300% | | | CHANGE AFTER HEAT/AGING @ 100° C. | | | | |
|---|---|---|---|---|---|---|---|---|---|
| | M | M | HARD. | C.S. | FOR 70 C | | | | |
| Tr | Kg/ | Kg/ | Kg/ | 70° C. | HARD | TS | TR | Sin | 100% M |
| No | cm² | Cm² | cm² | 24 Hr | IRHD | % | % | % | % |
| 1 | 129.10 | 200.45 | 67.5 | 15.89 | +4.5 | −43.33 | −45.52 | −53.66 | +48.57 |
| 2 | 111.2 | 172.77 | 66.0 | 16.79 | +3.5 | −20.96 | −35.60 | −34.99 | +33.22 |
| 3 | 128.24 | 194.77 | 67.3 | 14.0 | +4.33 | −24.62 | −35.95 | −33.24 | +27.70 |

We claim:

1. A predispersion of a rubber additive with improved dispersion comprising a rubber additive dispersed in a polymeric blend comprising of a (i) a polymeric component selected from the group consisting of copolymers of ethylene and vinyl acetate, ethylene-butyl acrylate copolymers, ethylene methyl acrylate copolymers, copolymers of ethylene and methacrylic acid, ethylene acrylic acid copolymers and derivatives thereof such as ethylene acrylic ester and maleic anhydride terpolymer, copolymers of ethylene and alkyl acrylate selected from the group consisting of ethylenemethyl acrylate copolymers, ethyleneethyl acrylate copolymers, ethylenepropyl acrylate copolymers, ethylenebutyl acrylate copolymers, ethylenebutyl acrylate/carbon monoxide terpolymers, ethyleneethyl, acrylate/maleic anhydride terpolymers and ethyleneacrylate/glycidyl methacrylate terpolymers, and any derivatives thereof and metal ionomers of copolymers of ethylene with acids, and any derivatives thereof, (ii) a rubbery material selected from the group consisting of copolymers of ethylene and propylene selected from the group consisting of ethylene propylene rubber, terpolymers of ethylene, propylene and a diene such as ethylene-propylene-diene monomer rubber, ethylene acrylate rubber, neoprene and epoxidised natural rubber, and (iii) a low molecular weight hydrocarbon selected from the group consisting of polyisobutene, atactic polypropylene, liquid polypropylene and low molecular weight waxes, whether grafted or not.

2. A predispersion as claimed in claim 1 wherein the amount of the rubber additive in the predispersion comprises from 5 to 95% by weight and that of the polymeric blend comprises 95 to 5% by weight of the total predispersion.

3. A predispersion as claimed in claim 1 wherein the rubber additive is selected from the group consisting of accelerators, antioxidants, activators, stabilizers, retarders, blowing agents, sulfur donors, curing agents, cross-linking activators, peroxides, flame retardants, processing promoters, peptizing agents, reclaiming agents, dispersants, lubricants, dispersing resins, homogenizers, tackifiers, reinforcers and cross-linking agents.

4. A predispersion as claimed in claim 1 wherein the rubber additive is selected from the group consisting of sulphur, 2-mercaptobenzotriazole, tetramethylthiuram disulfide, benzothazyl disulfide, zinc dibutyldithiocarbamate, zinc diethyldithiocarbamate, N-cyclohexyl-2-benzothazyl sulfenamide and N-oxydiethylene-2-benzothiazylsulfenamide.

5. A predispersion as claimed in claim 1 wherein the metal ionomer of copolymer of ethylene with acid is metal ionomer of copolymer of ethylene with methacrylic acid said metal being selected from the group consisting of zinc, sodium and lithium or salts thereof.

6. A process for the preparation of a predispersion of a rubber additive with improved predispersion comprising a rubber additive dispersed in a polymeric blend comprising of a (i) a polymeric component selected from the group consisting of copolymers of ethylene and vinyl acetate, ethylene-butyl acrylate copolymers, ethylene methyl acrylate copolymers, copolymers of ethylene and methacrylic acid, ethylene acrylic acid copolymers and derivatives thereof such as ethylene acrylic ester and maleic anhydride terpolymer, copolymers of ethylene and alkyl acrylate selected from the group consisting of ethylenemethyl acrylate copolymers, ethyleneethyl acrylate copolymers, ethylenepropyl acrylate copolymers, ethylenebutyl acrylate copolymers, ethylenebutyl acrylate/carbon monoxide terpolymers, ethyleneethyl acrylate/maleic anhydride terpolymers and ethyleneacrylate/glycidyl methacrylate terpolymers, and any derivatives thereof and metal ionomers of copolymers of ethylene with acids, and any derivatives thereof, (ii) a rubbery material selected from the group consisting of copolymers of ethylene and propylene selected from the group consisting of ethylene propylene rubber, terpolymers of ethylene, propylene and a diene such as ethylene-propylene-diene monomer rubber, ethylene acrylate rubber, neoprene and epoxidised natural rubber, and (iii) a low molecular weight hydrocarbon selected from the group consisting of polyisobutene, atactic polypropylene, liquid polypropylene and low molecular weight waxes, whether grafted or not, said process comprising mixing said additive in said polymeric blend.

7. A process as claimed in claim 6 wherein the amount of the rubber additive in the predispersion comprises from 5 to 95% by weight and that of the polymeric blend comprises 95 to 5% by weight of the total predispersion.

8. A process as claimed in claim 6 wherein the rubber additive is selected from the group consisting of sulphur, 2-mercaptobenzotriazole, tetramethylthiuram disulfide, benzothazyl disulfide, zinc dibutyldithiocarbamate, zinc diethyldithiocarbamate, N-cyclohexyl-2-benzothazyl sulfenamide and N-oxydiethylene-2-benzothiazylsulfenamide.

9. A process as claimed in claim 6 wherein the metal ionomers of copolymers of ethylene with acid comprises a metal ionomer of copolymer of ethylene with methacrylic acid said metal being selected from the group consisting of zinc, sodium and lithium or salts thereof.

10. A process as claimed in claim 6 wherein the mixing of the rubber additive in the said polymeric blend is carried out by melt mixing in an intermix or a kneader or two roll mill.

11. A process as claimed in claim 6 wherein the process for the preparation of the predispersion comprises first forming the polymeric blend by any conventional means such as melt mixing and subsequently dispersing the rubber additive therein by melt mixing.

12. A process as claimed in claim 6 wherein the predispersion is prepared by first mixing the polymeric component rubbery component and then adding the low molecular weight hydrocarbon and the rubber additive simultaneously thereto to form the final predispersion.

13. A process as claimed in claim 6 wherein the all components of the predispersion are simultaneously melt mixed to obtain the predispersion.

14. A polymeric blend for use in the preparation of predispersions of rubber additives with improved predispersion comprising (i) a polymeric component selected from the group consisting of copolymers of ethylene and vinyl acetate, ethylene-butyl acrylate copolymers, ethylene methyl acrylate copolymers, copolymers of ethylene and methacrylic acid, ethylene acrylic acid copolymers and derivatives thereof such as ethylene acrylic ester and maleic anhydride terpolymer, copolymers of ethylene and alkyl acrylate selected from the group consisting of ethylenemethyl acrylate copolymers, ethyleneethyl acrylate copolymers, ethylenepropyl acrylate copolymers, ethylenebutyl acrylate copolymers, ethylenebutyl acrylate/carbon monoxide terpolymers, ethyleneethyl acrylate/maleic anhydride terpolymers and ethyleneacrylate/glycidyl methacrylate terpolymers, and any derivatives thereof and metal ionomers of copolymers of ethylene with acids, and any derivatives thereof, (ii) a rubbery material selected from the group consisting of copolymers of ethylene and propylene selected from the group consisting of ethylene propylene rubber, terpolymers of ethylene, propylene and a diene such as ethylene-propylene-diene monomer rubber, ethylene acrylate rubber, neoprene and epoxidised natural rubber, and (iii) a low molecular weight hydrocarbon selected from the group consisting of polyisobutene, atactic polypropylene, liquid polypropylene and low molecular weight waxes, whether grafted or not.

15. A polymeric blend as claimed in claim 14 wherein the metal ionomers of copolymers of ethylene with acid comprises a metal ionomer of copolymer of ethylene with methacrylic acid, said metal being selected from the group consisting of zinc, sodium and lithium or salts thereof.

16. A polymeric blend as claimed in claim 14 wherein the amount of the polymeric component of the polymeric blend in the range of 5 to 70% by weight of the total blend.

17. A polymeric blend as claimed in claim 14 wherein the amount of the rubbery compound in the polymeric blend is in the range of 15 to 70% by weight of the total blend.

18. A polymeric blend as claimed in claim 14 wherein the amount of the low molecular weight hydrocarbon in the polymeric blend is in the range of 10 to 80% by weight of the total blend.

19. A polymeric blend as claimed in claim 14 wherein the polymeric component is selected from ethylene vinyl acetate and ethylene vinyl butylate, the rubbery component comprises ethylene-propylene diene monomer rubber (EPDM), and the lower molecular weight hydrocarbon is an unsaturated polyolefin with 3 or more carbon atoms.

20. A polymeric blend as claimed in claim 14 wherein the polymeric blend additionally comprises one or more conventional ingredients selected from plasticizers, thickeners, viscosity enhancers, anti-oxidants, binders and waxes.

21. A process for the preparation of a polymeric blend for use in the preparation of predispersions of rubber additives with improved predispersion comprising mixing (i) a polymeric component selected from the group consisting of copolymers of ethylene and vinyl acetate, ethylene-butyl acrylate copolymers, ethylene methyl acrylate copolymers, copolymers of ethylene and methacrylic acid, ethylene acrylic acid copolymers and derivatives thereof such as ethylene acrylic ester and maleic anhydride terpolymer, copolymers of ethylene and alkyl acrylate selected from the group consisting of ethylenemethyl acrylate copolymers, ethyleneethyl acrylate copolymers, ethylenepropyl acrylate copolymers, ethylenebutyl acrylate copolymers, ethylenebutyl acrylate/carbon monoxide terpolymers, ethyleneethyl acrylate/maleic anhydride terpolymers and ethyleneacrylate/glycidyl methacrylate terpolymers, and any derivatives thereof and metal ionomers of copolymers of ethylene with acids, and any derivatives thereof (ii) a rubbery material selected from the group consisting of copolymers of ethylene and propylene selected from the group consisting of ethylene propylene rubber, terpolymers of ethylene, propylene and a diene such as ethylene-propylene-diene monomer rubber, ethylene acrylate rubber, neoprene and epoxidised natural rubber, and (iii) a low molecular weight hydrocarbon selected from the group consisting of polyisobutene, atactic polypropylene, liquid polypropylene and low molecular weight waxes, whether grafted or not.

22. A process as claimed in claim 21 wherein the metal ionomers of copolymers of ethylene with acid comprises a metal ionomer of copolymer of ethylene with methacrylic acid, said metal being selected from the group consisting of zinc, sodium and lithium or salts thereof.

23. A process as claimed in claim 21 wherein the amount of the polymeric component of the polymeric blend in the range of 5 to 70% by weight of the total blend.

24. A process as claimed in claim 21 wherein the amount of the rubbery compound in the polymeric blend is in the range of 15 to 70% by weight of the total blend.

25. A process as claimed in claim 21 wherein the amount of the low molecular weight hydrocarbon in the polymeric blend is in the range of 10 to 80% by weight of the total blend.

26. A process as claimed in claim 21 wherein one or more conventional additives selected from the group consisting of plasticizers, thickeners, binders, anti-oxidants, viscosity modifying agents and waxes are added to the polymeric blend.

27. A process as claimed in claim 21 wherein the polymeric blend is formed by first melt mixing the polymeric component and the rubbery component to obtain a first blend and then adding the low molecular weight hydrocarbon to obtain the final composition.

28. A process as claimed in claim 27 wherein all components of the polymeric blend are melt mixed simultaneously to obtain the final blend.
